(19) United States
(12) Patent Application Publication
(10) Pub. No.: US 2024/0404376 A1
(43) Pub. Date: Dec. 5, 2024

(54) Room Clearance Indication Light

(71) Applicant: Greg J. Kennedy, Moab, UT (US)

(72) Inventors: Greg J Kennedy, Moab, UT (US); Vincent S. Warner, American Fork, UT (US)

(73) Assignee: Greg J. Kennedy, Moab, UT (US)

(21) Appl. No.: 18/676,658

(22) Filed: May 29, 2024

Related U.S. Application Data
(60) Provisional application No. 63/470,052, filed on May 31, 2023.

(51) Int. Cl. G08B 5/36; F21L 4/00; F21V 21/088; F21V 23/04; G08B 21/22

(52) U.S. Cl. CPC G08B 5/36; F21L 4/00; F21V 21/088; F21V 23/0414; G08B 21/22

(57) ABSTRACT

A room clearance indication light may feature opposed rocker switches which interact with each other to prevent the accidental actuation of the primary, switch rocker unless the secondary, interlock rocker is simultaneously depressed. The interlock rocker also controls the attachment gate, allowing the indication light to be efficiently positioned and removed from worn or other stowage equipment. The opposed position of the rockers allows simultaneous actuation with a simple grab by the hands in preparation for throwing into a cleared room while the ability to actuate the interlock rocker without simultaneously actuating the switch rocker allows for individualized placement of the indicator lights prior to use. Switch structures may be as simple as a compression switch, which is actuated from pressure from the switch rocker, or may utilize a rotary selection switch advanced by actuation of the switch rocker.

### CROSS-REFERENCES TO RELATED APPLICATIONS

The present invention claims priority as a non-provisional perfection of prior filed U.S. Application No. 63/470,052, filed on May 31, 2023 and incorporates the same by reference herein in its entirety.

### FIELD OF THE INVENTION

The present invention relates to the field of public safety and more particularly relates to a room clearance indicator light with opposed rocker switches to better control both actuation and de-actuation of its activation switch.

### BACKGROUND OF THE INVENTION

Our military and police forces are frequently in tactical situations where teams of individuals must enter a structure and verify that no hostile agents or injured victims are found therein. Often this involves entering and quickly inspecting a room to “clear” the room and verify there is no danger contained therein. Afterwards, individuals will then mark the room in some way to indicate to others that the room is clear. Presently, many tools have been used in the past and currently, including chemical light sticks, chalk, tape, and other light sources. Chemical light sticks must be broken and thrown in to a room. The advantages of chemical light sticks are numerous in that they are cheaply acquired, easily actuated, and provide light which not only is easily seen in darker environments to indicate clearance, but also provides a limited amount of light to the environment. However, breaking the capsule contained within these light sticks to activate them is somewhat time consuming in the middle of a tactical situation and requires that the user divide attention between the tactical situation and the activation of the sticks. In addition, chemical lights can be accidentally activated when pushed against during the tactical operation. Chalk and tape take extra time and require diverting the operator's attention. Other light sources may also be accidentally activated or deactivated in the same way. What is needed is a cost-effective, quickly deployable way to intuitively light an indicator while virtually eliminating accidental activation or deactivation for use in room clearance situations.

The present invention is a room clearance indication light which is both intuitive to use and is also structured to prevent accidental actuation and de-actuation of the light. The present invention represents a departure from the prior art in that the room clearance indication light of the present invention allows for both the actuation of the indicator light with the removal from any mounting structure in one motion, while preventing accidental activation or deactivation of the light through opposed rocker switches. Alternate switch structures for the room clearance light are disclosed.

### SUMMARY OF THE INVENTION

In view of the foregoing disadvantages inherent in the known types of clearance indicators, an improved room clearance indicator light may meet the following objectives: that is be easy and intuitive to use, that it reduced incidents of accidental switch actuations, that it be easily and economically manufactured, that it be reusable, and that it effectively indicates that a room has been cleared. As such, a new and improved room clearance indicator light may comprise opposed rocker switches which may interact in a manner to prevent accidental actuation of the light to accomplish these objectives.

The more notable features of the invention have thus been outlined in order that the more detailed description that follows may be better understood and in order that the present contribution to the art may be better appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in several ways. Also, it is to be understood that the phraseology and terminology employed herein are for description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions as far as they do not depart from the spirit and scope of the present invention.

### BRIEF DESCRIPTION OF THE DRAWINGS

To describe the way the above-recited and other advantages and features of the invention can be obtained, a more particular description of the invention briefly described above will be rendered by reference to specific example embodiments thereof which are illustrated in the appended drawings. Understanding that these drawings depict only typical embodiments of the invention and are therefore not to be considered as limiting of its scope, the invention will be described and explained with additional specificity and detail using the accompanying drawings.

FIG. 1 is a perspective view of an exemplary room clearance indication light.

FIG. 2 is a front elevation of the room clearance indication light of FIG. 1.

FIG. 3 is a rear elevation of the room clearance indication light of FIG. 1.

FIG. 4 is a bottom plan view of the room clearance indication light of FIG. 1.

FIG. 5 is a right elevation of the room clearance indication light of FIG. 1.

FIG. 6 is a left elevation of the room clearance indication light of FIG. 1.

FIG. 7 is a sectional view of the room clearance indication light of FIG. 6, taken along line VII-VII.

FIG. 8 is a sectional view of the room clearance light of FIG. 7, unlocked.

FIG. 9 is a sectional view of the room clearance light of FIG. 7, actuated.

FIG. 10 is an exploded view of the room clearance light of FIG. 1.

FIG. 11 is an exploded view of an alternate embodiment of a room clearance light.

FIG. 12 is an alternate exploded view of the room clearance light of FIG. 11.

FIG. 13 is a sectional view of the room clearance light of FIG. 11, along the same line as FIG. 7 and in an activated state.

FIG. 14 is a sectional view of the room clearance light of FIG. 11, unlocked and with the spring removed for clarity.

FIG. 15 is a sectional view of the room clearance light of FIG. 14, deactivated.

FIG. 16 is a sectional view of the room clearance light of FIG. 14, unlocked in the deactivated state.

FIG. 17 is a sectional view of the room clearance light of FIG. 14, reactivated.

### DESCRIPTION

With reference now to the drawings, a preferred embodiment of the room indicator light is herein described. It should be noted that the articles “a,” “an,” and “the,” as used in this specification, include plural referents unless the content clearly dictates otherwise. Reference numerals are consistent throughout the drawings and indicate the following:
10—First Embodiment of a Room Clearance Indicator Light;
12—Front Casing;
14—Rear Casing;
16—Battery Cover;
18—Securement Screws;
20—Interlock Rocker;
22—Interlock Block;
24—Gate;
26—Interlock Rocker Pivot;
30—Switch Rocker;
32—Switch Block;
40—Spring;
50—Battery;
52—Compression Switch;
54—Light Source;
100—Second Embodiment of a Room Clearance Light;
112—Front Casing;
114—Rear Casing;
116—Battery Cover;
118—Securement Screws;
120—Interlock Rocker;
122—Interlock Block;
124—Gate;
126—Interlock Rocker Pivot;
130—Switch Rocker;
132—Switch Block;
134—Switch Selector Hook;
136—Switch Rocker Pivot Point
140—Spring;
144—Pawl Break;
150—Rotary Selector Gear;
152—Front Gear Teeth;
154—Rear Gear Teeth;
156—Blade Switch;
158—Light Source;
160—Light Source Lead; and,
C—Rotary Selector Wheel Centerline.

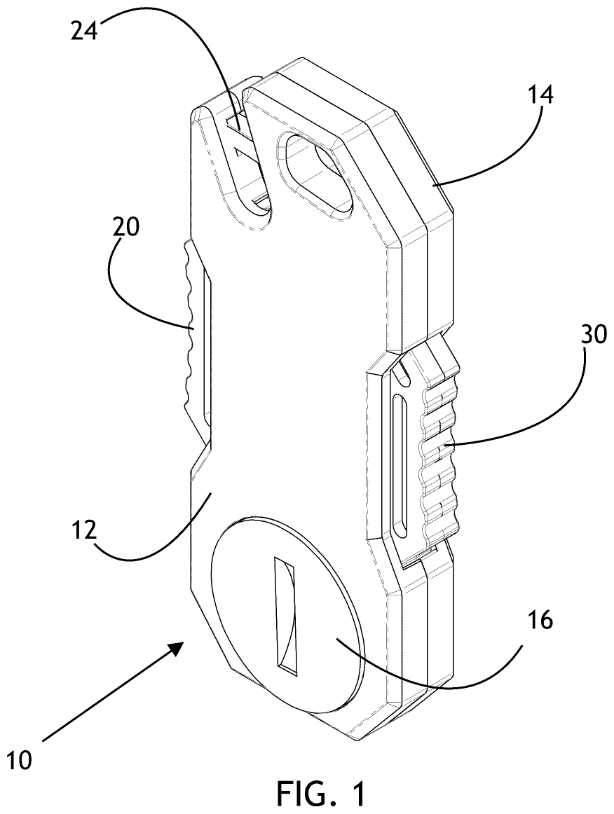

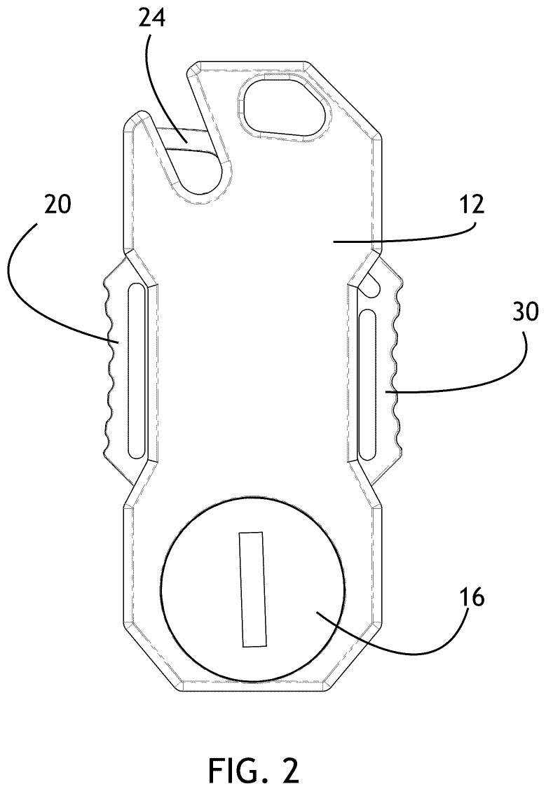

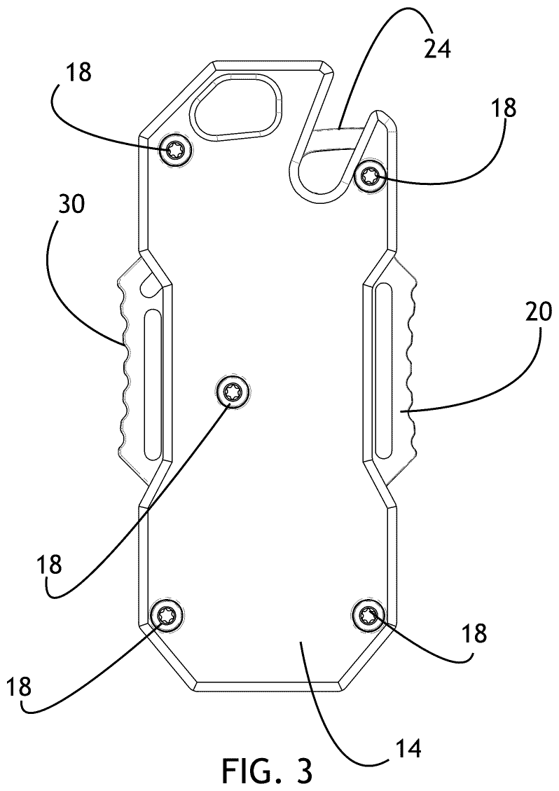

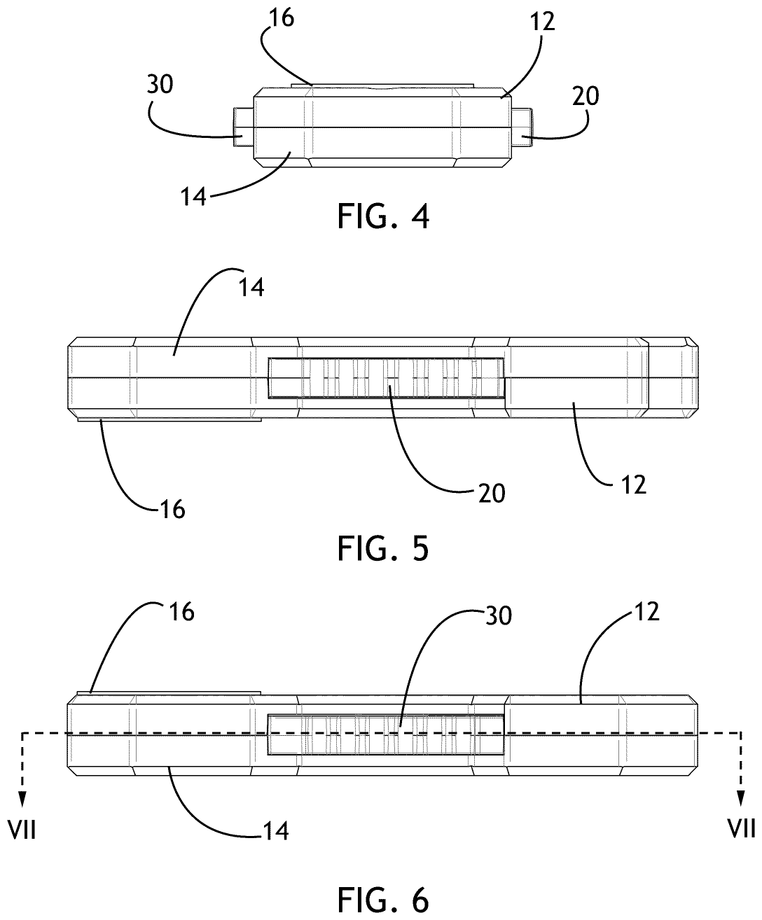

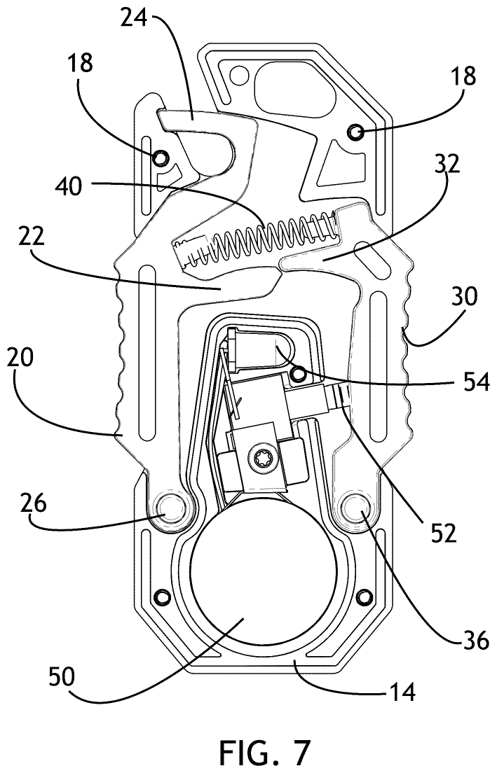

With reference to FIGS. 1-6, the room clearance indicator 10 may be a hand-held, mountable light with translucent or transparent front 12 and rear 14 casings secured with screws or bolts 18 onto a contiguous whole. As used in the specification, the generic word “casing” without a specific reference to either the “front” or “rear” shall refer to the two casings together unless context dictates otherwise. The first embodiment of the indicator light presents two rockers 20, 30 on opposed lateral sides and a gate 24, part of the interlock rocker 20, at a top of the unified casing structure. A battery cover 16 is provided to secure the battery 50, or batteries, (FIG. 7) and circuitry in a water-resistant environment. As seen in FIG. 7, a light source 54, which is preferred to be an LED, is contained within the opposed casing halves along with a wiring harness connected to the battery 50 and an operable compression switch 52.

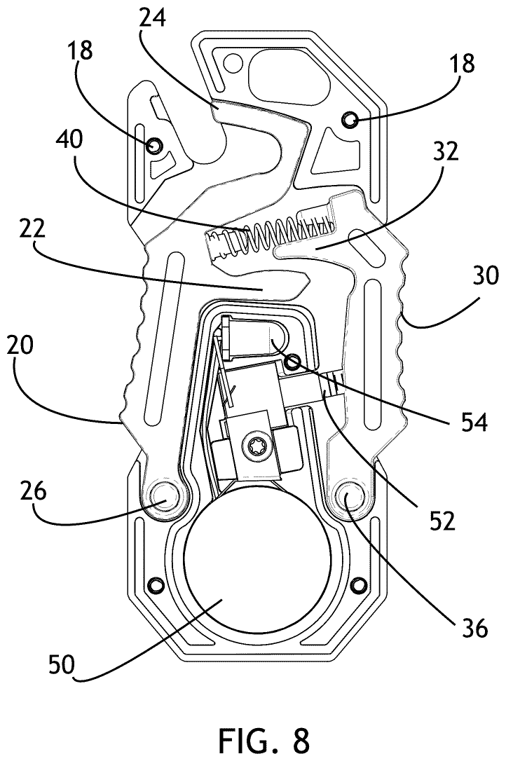

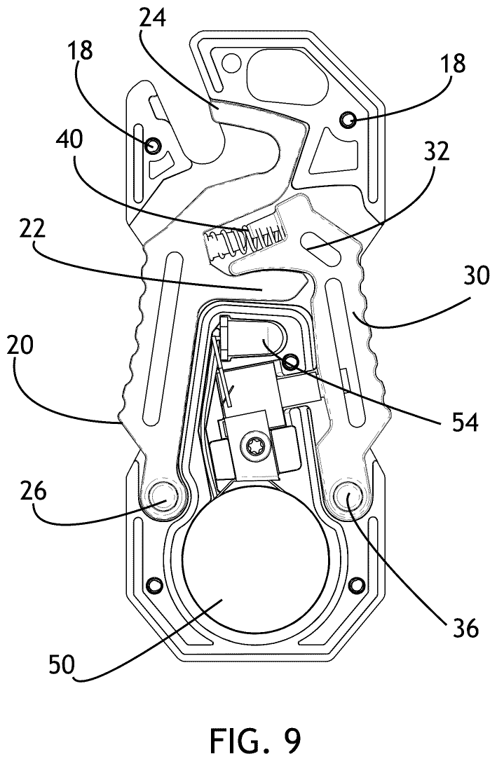

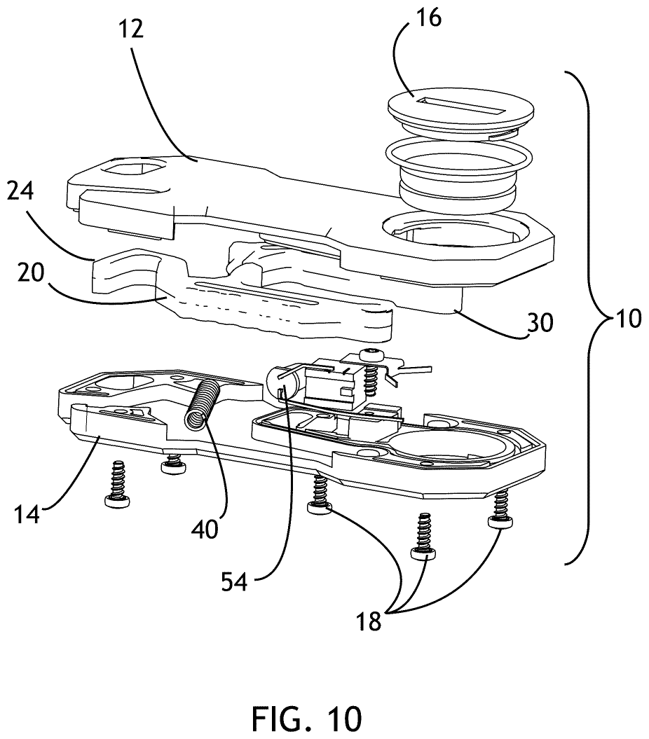

As can be seen in FIG. 7, interlock rocker 20 and switch rocker 30 are pivotably mounted 26, 36 proximate the battery 50 and are biased apart by a centrally mounted biasing spring 40 spanning the interior of the casing. The depicted spring 40 is a simple coil spring mounted on opposed spurs on the inner side of each rocker. Understandably, other biasing mechanisms may be utilized and developed so long as they are sufficient to maintain the rockers 20, 30 apart from each other unless acted upon. Interlock rocker 20 features a gate 24 opposite the pivot 26. The gate 24 is a recurved hook that extends through the casing across a corner channel formed in the casing's upper corner. Actuation of the interlock rocker 20 will bias the gate 24 and remove it from across the channel (FIG. 8). This gate 24 may then be used to mount the clearance indication light upon equipment, including carabiners and/or a MOLLE mounting system commonly on worn clothing or tactical equipment. The user just opens the gate 24 and clips the indicator light wherever desired, and when using the light, simply reverses the process.

The two rockers 20, 30 must be actuated together to activate or deactivate the light. Actuation of the interlock rocker 20 alone does not actuate the switch 52 to turn the light source 54 on or off. The interlock rocker 20 also features an inward facing interlock block 22 which interfaces with a corresponding switch rocker block 32. When the interlock rocker 20 is not actuated, the interlock block 22 prevents the actuation of the switch rocker 30. As can be seen in FIG. 8, actuation of the interlock rocker 20 not only opens gate 24 but biases the interlock rocker block 22 downward and out of engagement with the switch rocker block 32. The switch rocker 30, with is similarly pivotably mounted 36, may then be actuated (FIG. 9) and the body of the switch rocker 30 will depress the switch 52, activating, or deactivating, the light source 54. In this manner, the user may mount the indicator light wherever desired without activating the light. When in use, and time is of the essence, the simple motion of grabbing the indicator light 10, and depressing both rockers 20, 30, will not only open gate 24, but also simultaneously turn the light 54 on. The user may then throw the indicator light into a cleared room to indicate its status. Since deactivation of the light 54 requires depression of both opposed rockers 20, 30, incidents of accidental deactivation should be virtually eliminated. After the operation is complete and there is time, the user may optionally then return to cleared rooms and gather the indicator lights, turning them off as collected and placing them on a desired stowage structure.

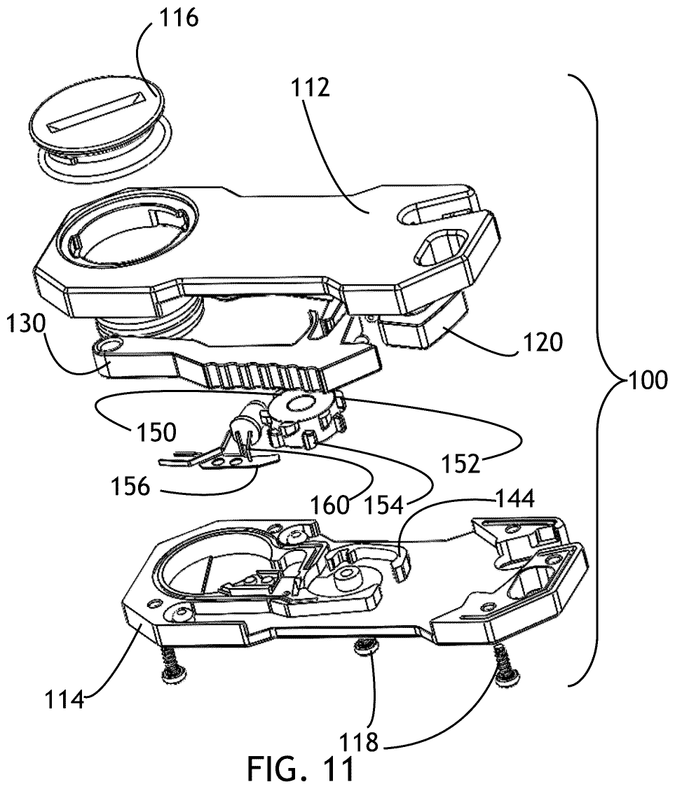

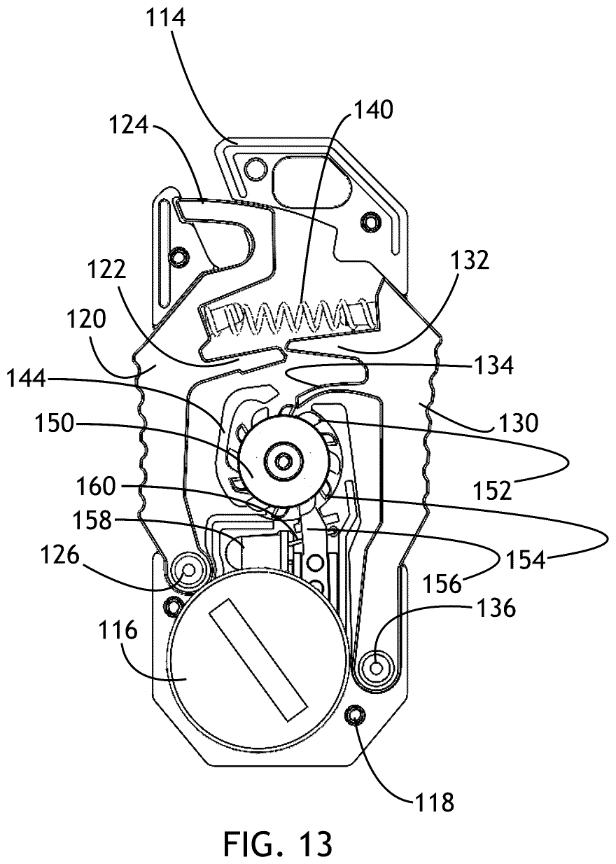

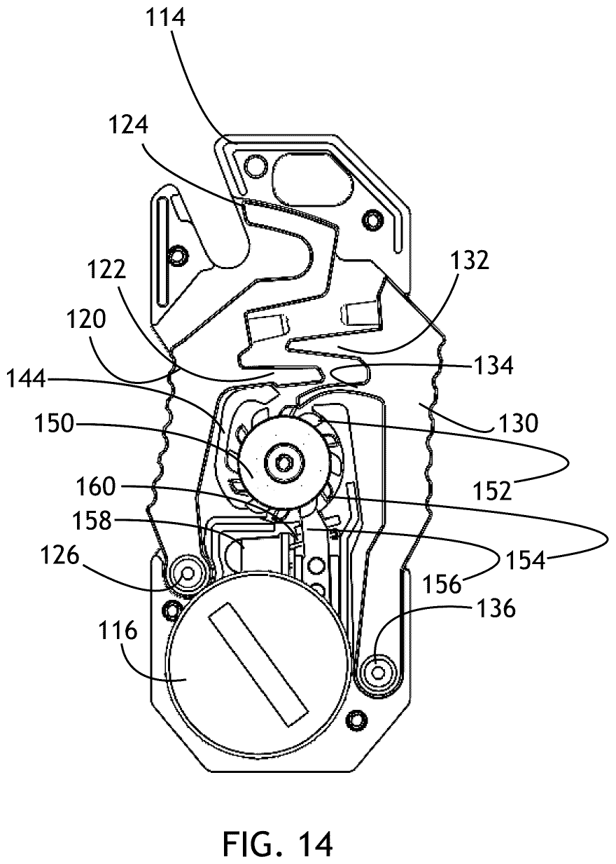

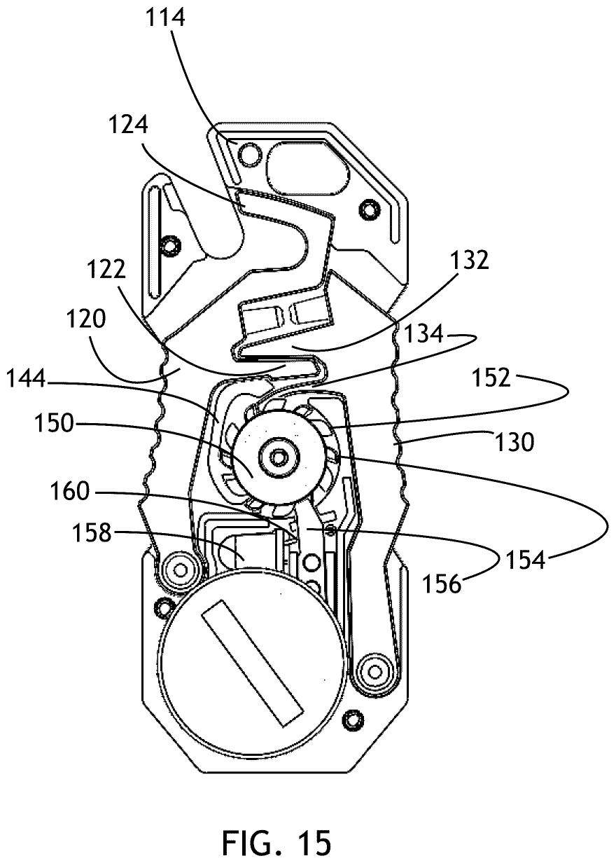

An alternate embodiment, shown in FIGS. 11-17, may change the structure of the switch. As with the previously described embodiment, two opposed rockers 120, 130 present blocks 122, 132 that project inwardly and prevent the depression of the switch rocker 130 unless the interlock rocker 120 is first depressed. Interlock rocker 120 and switch rocker 130 are pivotably mounted 126, 136 proximate the battery (represented by battery cover 116) and are biased apart by a centrally mounted biasing spring 140 spanning the interior of the casing. The gate 124 is also presented on the interlock rocker 120 and will move away from the channel when said interlock rocker 120 is depressed. Interlock block 122 and switch block 132 will interact if the rockers are depressed simultaneously (FIG. 13) or if the switch rocker 130 is depressed first. However, as with the previous embodiment, depressing the interlock rocker 120 first will move the interlock block 122 (FIG. 14) out of the way so that the switch rocker 130 may be depressed (FIG. 15).

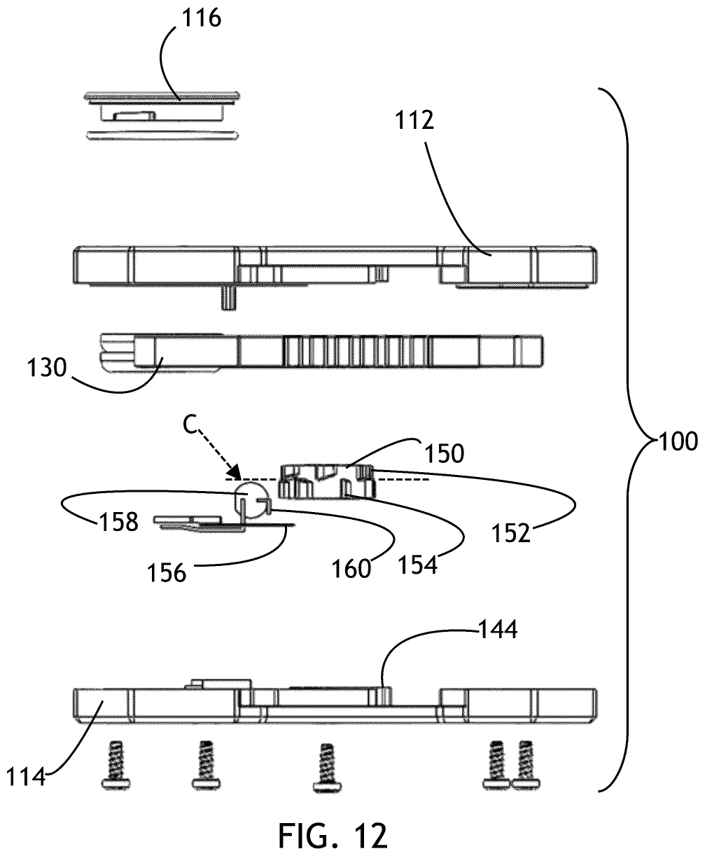

The switch structure is a rotating selector wheel 150 which interfaces with a blade switch 156 to make or break contact with a lead 160 from a light source (such as LED 158). Selector wheel 150 presents two sets of angled teeth, which may be called front teeth 152 and rear teeth 154 to comport with the naming nomenclature of the front 112 and rear 114 casing sides. The sets of teeth are alternating (FIG. 12) and present opposed angled surfaces which will interface with the blade switch 156 which will be naturally disposed along a centerline C of the wheel 150. In addition to the rotary switch 150, this second embodiment presents a switch selector hook 134 projecting inwards from the switch rocker 130, underneath the switch block 132. This selector hook 134 will arc with the rocker and interface with an individual teeth of the rotary selector wheel 150. This interaction will force the wheel 150 to advance as either a front 152 or rear 154 tooth is pushed forward (FIGS. 13-17). As the wheel 150 advances, the teeth will interact with the pawl break 144 and reverse rotation will be prohibited due to the ratcheting relation between the teeth and pawl break 144. It is possible that the pawl break may be a separate structure, such as break 144 illustrated in the figures, or may be a feature of the blade switch 158.

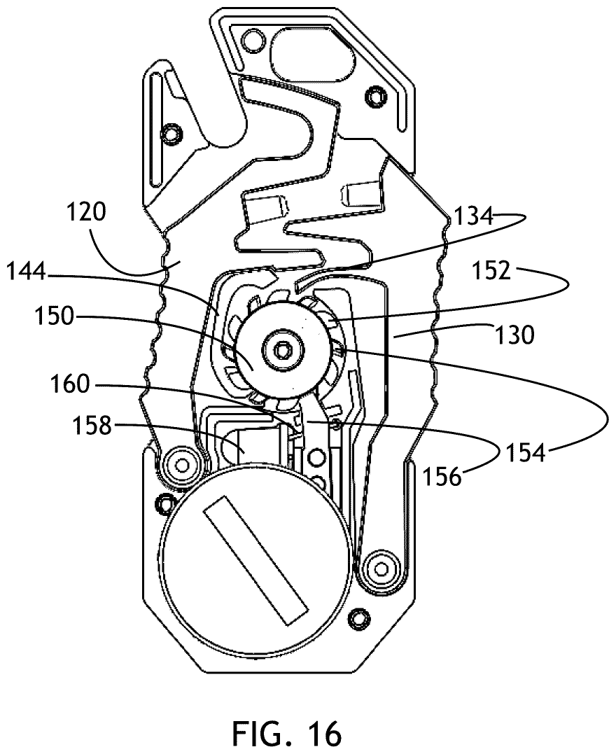

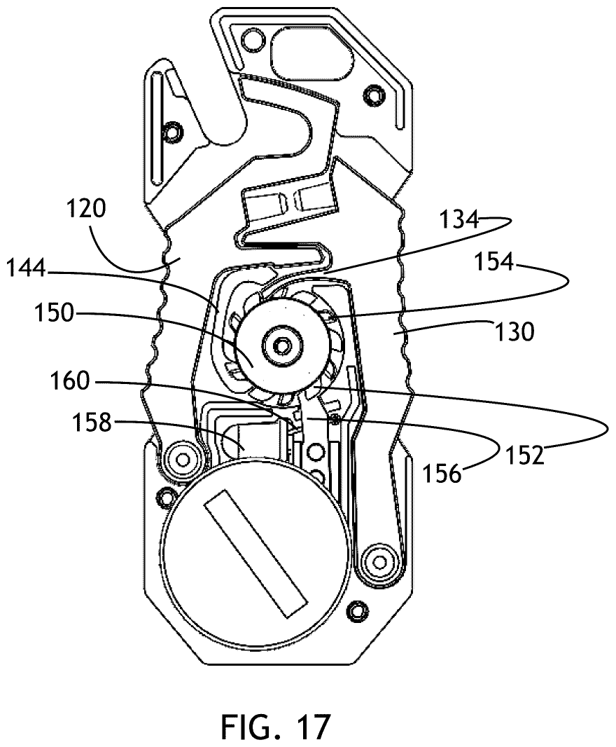

Each set of teeth 152, 154 presents an angled inner surface (facing center line C) that will bias the blade switch 158 either into or away from the lead 160 as the teeth interact with blade switch 158. The progression is seen in FIGS. 13-17, where the indicator light starts with neither rocker depressed (FIG. 13), then the interlock rocker 120 depressed (FIG. 14), and the switch rocker 130 successively depressed (FIGS. 15-17) to deactivate the indicator light (FIG. 15), reset the switch rocker's position for another actuation (FIG. 16), and reactivating the indicator light (FIG. 17). With each successive iteration, the blade switch 158 will interface with the angled surface of a member of one or the other sets of teeth 152, 154. The teeth faces extend from one side of the center line C to the other, allowing each tooth to catch and bias the blade switch 158 towards the activated or deactivated positions. The depicted orientation has the front set of teeth activating the switch, but it is well understood that this orientation could be reversed, or possibly added to in an effort to cycle through different states or colors. Together, activated, deactivated, and any other circuit state of the indicator light, including, without limitation, intensity or color, will be termed “states of actuation” in the appended claims.

Although the present invention has been described with reference to preferred embodiments, numerous modifications and variations can be made and still the result will come within the scope of the invention. The described embodiments are to be considered in all respects only as illustrative and not restrictive. No limitation with respect to the specific embodiments disclosed herein is intended or should be inferred. Therefore, the scope of the invention is indicated by the appended claims rather than by the foregoing description. All changes which come within the meaning and range of equivalency of the claims are to be embraced within their scope.

What is claimed is:

1. A room clearance indication light comprising:
a. a casing containing a light source and a power source and switch mechanism for said light source, the casing defining opposed lateral sides and opposed top and bottom sides, the top side further defining a corner channel;
b. an interlock rocker extending through the casing on one lateral side and pivotably mounted proximate the bottom side and extending internally within the casing, the interlock rocker further comprising a gate extending across the corner channel and an inward projecting interlock block structure;
c. a switch rocker extending through a lateral side opposite the interlock rocker, likewise pivotably mounted proximate the bottom side, the switch rocker further comprising an inward projecting switch block structure; and
d. a spring structure located within the casing between the interlock rocker and the switch rocker, biasing said interlock rocker and switch rocker apart;
wherein, the interlock block structure and switch block structure interface in a manner to prevent actuation of the switch rocker unless the interlock rocker is at least simultaneously actuated however the interlock rocker may be actuated independently of the switch rocker, thereby removing the gate from across the corner channel.

2. The room clearance indicator light of claim 1, further comprising a switch which interfaces with the switch rocker to cycle through states of activation with each depression of the switch rocker.

3. The room clearance indicator light of claim 2, the switch being a compression switch pressed by the switch rocker during actuation.

4. The room clearance light of claim 2, the switch further comprising:
a rotary selection wheel having a plurality of rows of alternating teeth;
a pawl break;
a blade switch; and
a switch hook, located on the switch rocker, which will interface with and advance the rotary selection wheel as the switch rocker is actuated.

5. A room clearance indication light comprising:
a. a casing defining opposed lateral sides and opposed top and bottom sides, the top side further defining a corner channel;
b. an interlock rocker extending through the casing on one lateral side and pivotably mounted proximate the bottom side and extending internally within the casing, the interlock rocker further comprising a gate extending across the corner channel and an inward projecting interlock block structure; and
c. a switch rocker extending through a lateral side opposite the interlock rocker, likewise pivotably mounted proximate the bottom side, the switch rocker further comprising an inward projecting switch block structure; and
wherein, the interlock rocker and switch rocker are biased apart and the interlock block structure and switch block structure interface in a manner to prevent actuation of the switch rocker unless the interlock rocker is at least simultaneously actuated however the interlock rocker may be actuated independently of the switch rocker, thereby removing the gate from across the corner channel.

6. The room clearance indicator light of claim 5, further comprising a switch which interfaces with the switch rocker to cycle through states of activation with each depression of the switch rocker.

7. The room clearance indicator light of claim 6, the switch being a compression switch pressed by the switch rocker during actuation.

8. The room clearance light of claim 6, the switch further comprising:
a rotary selection wheel having a plurality of rows of alternating teeth;
a pawl break;
a blade switch; and
a switch hook, located on the switch rocker, which will interface with and advance the rotary selection wheel as the switch rocker is actuated.
